(19) United States
(12) Patent Application Publication
(10) Pub. No.: US 2005/0178865 A1
(43) Pub. Date: Aug. 18, 2005

(54) Food chopper

(76) Inventor: Clifford G. Krause, Garland, TX (US)

Correspondence Address: GARY C. HONEYCUTT, 4728 RAVENDALE, RICHARDSON, TX, 75082, US

(21) Appl. No.: 10/778,989

(22) Filed: Feb. 17, 2004

(51) Int. Cl. A47J 43/00

(52) U.S. Cl. 241/169

(57) ABSTRACT

Apparatus for chopping food to produce particles of a desired size, including a first container for holding food to be chopped, in combination with a second container for receiving particles having the desired size. The two containers are separated by an apertured partition for screening chopped particles, so that particles of the desired size are selectively removed from the first container and collected in the second container, while the chopping process is underway. Means for adjusting the aperture size are also provided.

### FIELD OF THE INVENTION

This invention relates to apparatus for processing food; and more particularly to apparatus for cutting or chopping food to produce smaller pieces.

### BACKGROUND OF THE INVENTION

Numerous food chopper designs for home use have been commercially available for decades. All the known designs include a food container and a blade for chopping food in the container. The blade is usually mounted for reciprocating and/or rotational movement to strike the food repeatedly, until the average particle size has been reduced to meet the user's needs. The problem with these designs has always been the lack of control over particle size. That is, the blade usually strikes at random, hitting large and small particles equally, producing a wide distribution of particle sizes. At the end of the process, most of the particles will be either smaller or larger than the preferred size.

### SUMMARY OF THE INVENTION

The present invention provides an apparatus for chopping food, including means for selectively removing particles having a desired size, as they are produced, while the chopping process is underway. Examples of foods frequently processed in a food chopper include pecans and other nuts; onions, celery, and apples.

The apparatus includes a first container wherein chopping is carried out, in combination with a second container wherein selected particles are collected during the chopping process. The containers are separated by a partition having apertures therein which permit selected particles to pass from the first container into the second container. Thus, the user is able to recover a product having a very limited range of particle sizes, as desired, by selecting a partition having apertures just large enough to permit selective passage of particles having the desired size, as soon as they are formed. Removal of the desired particles from the first container as they are formed is essential in order to avoid subjecting the desired particles to further chopping.

Preferably the two containers are releaseably secured to each other, so that they may be conveniently separated, for removing the food particles collected in the second container; and also for the purpose of exchanging one partition for another partition having apertures of a different size. In another embodiment the partition consists of two apertured disks in combination, one of which is rotatable to provide partial obstruction of apertures in the other disk, thereby enabling the user to adjust the aperture size without separating the containers, and without interrupting the process.

In a preferred embodiment the first container is located vertically above the second container, so that the force of gravity causes selected particles to pass through the apertures in the partition. In another embodiment a stream of air is passed through the first container and through the partition, so that selected particles are swept through the apertured partition. In this embodiment the containers may be located side by side, since gravity is not the operative force relied upon to move particles through the partition.

### BRIEF DESCRIPTION OF THE DRAWINGS

FIG. 1 is a perspective view of a complete embodiment of the invention.

FIG. 2 is a perspective view of the second container showing an apertured partition comprising two disks, one of which is rotatable.

### DETAILED DESCRIPTION OF THE PREFERRED EMBODIMENTS

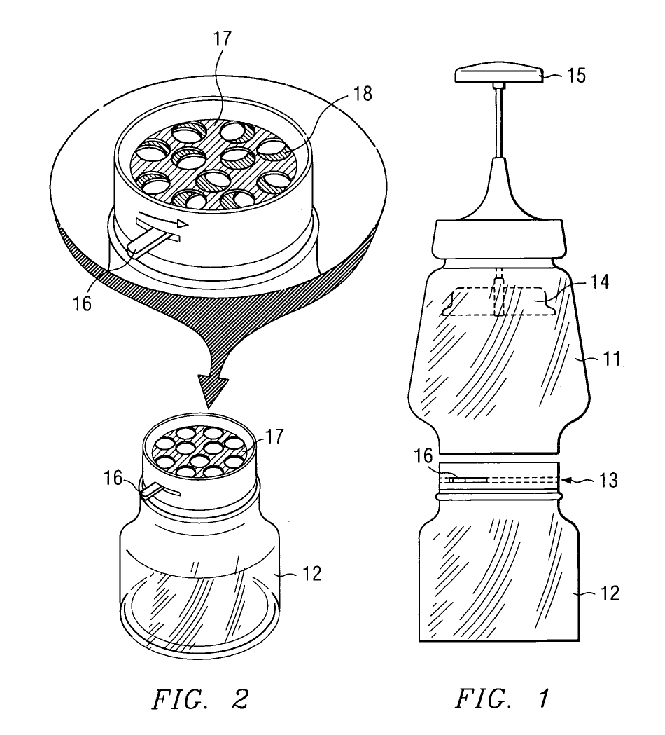

The apparatus of FIG. 1 includes a first container 11 in combination with a second container 12, separated by an apertured partition 13. Container 11 includes a chopping blade 14 operated by repeatedly pushing down on handle 15 until it strikes food particles in container 11 with sufficient force to cut through and divide larger particles into smaller sizes. As soon as particles are formed having a size smaller than the apertures of partition 13, the smaller particles fall through the apertures into second container 12. Thus the smaller particles are not subjected to further chopping action. The chopping is finished when substantially all particles fall through the apertures in the partition.

In FIG. 2, partition 13 of this embodiment is seen to include apertured disks 17 and 18. When the apertures of the two disks are fully aligned, as in the lower portion of the drawing, the effect is the same as having only one disk. Thus, when the full aperture diameter is desired, only one disk is needed. Adjustable apertures are provided by moving lever 16 a short distance, thereby rotating disk 18, in order to partially obstruct the apertures of disk 17, giving the combination a reduced aperture size.

In another embodiment, partition 13 consists of a single replaceable disk. Multiple disks are available, having apertures of different sizes, so that the user may select and insert a single disk having the desired aperture size.

1. A food chopper comprising:
a) a first container for holding food to be chopped;
b) a second container in combination with said first container, for holding chopped food;
c) a movable blade mounted within said first container, for chopping food; and
d) means for transferring selected food particles from said first container to said second container.

2. A chopper as in claim 1 wherein said means for transferring food particles comprises a partition between said containers, having apertures through which selected particles are passed.

3. A chopper as in claim 2 wherein said first container is located above said second container, and said partition has a generally horizontal orientation, thereby enabling selected particles to fall through said apertures by the force of gravity.

4. A chopper as in claim 2 wherein the size of said apertures is adjustable, to permit a selection of food particle sizes that will pass through.

5. A chopper as in claim 4 wherein said partition comprises first and second apertured disks in combination, one of which is rotatable to provide partial obstruction of apertures in the other disk.

6. A chopper as in claim 3 wherein said blade has a vertical orientation and is mounted to enable both reciprocating and rotational movement.

7. A method for dividing food into particles of a desired size, comprising the steps of:
a) randomly chopping said food to produce smaller particles, and
b) selectively removing particles of said desired size, while the chopping process is underway.
